(19) United States
(12) Patent Application Publication
(10) Pub. No.: US 2024/0147352 A1
(43) Pub. Date: May 2, 2024

(54) METHOD AND APPARATUS FOR SI ACQUISITION FOR NETWORK ENERGY SAVINGS IN WIRELESS COMMUNICATION SYSTEM

(71) Applicant: SAMSUNG ELECTRONICS CO., LTD., Suwon-si (KR)

(72) Inventors: Anil AGIWAL, Suwon-si (KR); Sangkyu BAEK, Suwon-si (KR)

(21) Appl. No.: 18/497,826

(22) Filed: Oct. 30, 2023

(30) Foreign Application Priority Data
Oct. 31, 2022 (KR) 10-2022-0142840

(51) Int. Cl. H04W 48/10; H04W 74/08

(52) U.S. Cl. CPC H04W 48/10; H04W 74/0833

(57) ABSTRACT

The disclosure relates to a 5G or 6G communication system for supporting a higher data transmission rate. A method performed by a terminal in a wireless communication system is provided. The method includes transmitting, to a first base station operating a first cell, a first message related to a random access procedure, the first message including information indicating whether the terminal needs broadcast information of a second cell, receiving, from the first base station, a second message as an acknowledgement of the first message, and receiving, from a second base station operating the second cell, the broadcast information.

### CROSS-REFERENCE TO RELATED APPLICATION

This application is based on and claims priority under 35 U.S.C. § 119 to Korean Patent Application No. 10-2022-0142840, filed on Oct. 31, 2022, in the Korean Intellectual Property Office, the disclosure of which is incorporated by reference herein in its entirety.

### BACKGROUND

### 1. Field

The disclosure relates to a wireless communication system. More particularly, the disclosure relates to an apparatus, a method and a system for network energy savings in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Network energy savings is impacted by periodically transmitted common channels/signals i.e., SSB, MIB and SIB1. A system and method are needed to minimize these transmissions as much as possible.

In accordance with an aspect of the disclosure, a method performed by a terminal in a wireless communication system is provided. The method includes transmitting, to a first base station operating a first cell, a first message related to a random access procedure, the first message including information indicating whether the terminal needs broadcast information of a second cell, receiving, from the first base station, a second message as an acknowledgement of the first message, and receiving, from a second base station operating the second cell, the broadcast information.

In accordance with another aspect of the disclosure, a method performed by a first base station operating a first cell in a wireless communication system is provided. The method includes receiving, from a terminal, a first message related to a random access procedure, the first message including information indicating whether the terminal needs broadcast information of a second cell, transmitting, to a second base station operating the second cell, information indicating the broadcast information based on the first message, and transmitting, to the terminal, a second message as an acknowledgement of the first message.

In accordance with another aspect of the disclosure, a terminal in a wireless communication system is provided. The terminal includes a transceiver and a controller coupled with the transceiver. The controller is configured to transmit, to a first base station operating a first cell, a first message related to a random access procedure, the first message including information indicating whether the terminal needs broadcast information of a second cell, receive, from the first base station, a second message as an acknowledgement of the first message, and receive, from a second base station operating the second cell, the broadcast information.

In accordance with another aspect of the disclosure, a first base station operating a first cell in a wireless communication system is provided. The first base station includes a transceiver and a controller coupled with the transceiver. The controller is configured to receive, from a terminal, a first message related to a random access procedure, the first message including information indicating whether the terminal needs broadcast information of a second cell, transmit, to a second base station operating the second cell, information indicating the broadcast information based on the first message, and transmit, to the terminal, a second message as an acknowledgement of the first message.

According to an embodiment of the disclosure, the network energy can be efficiently saved when a UE acquire system information (SI).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a procedure for acquisition of system information according to an embodiment of the present disclosure;

FIG. 2 illustrates a procedure for acquisition of system information according to an embodiment of the present disclosure;

FIG. 3 illustrates a procedure for acquisition of system information according to an embodiment of the present disclosure;

FIG. 4 illustrates a procedure for acquisition of system information according to an embodiment of the present disclosure;

FIG. 5 illustrates a procedure for acquisition of system information according to an embodiment of the present disclosure;

FIG. 6 illustrates a procedure for acquisition of system information according to an embodiment of the present disclosure;

FIG. 7 illustrates a procedure for acquisition of system information according to an embodiment of the present disclosure;

FIG. 8 illustrates a terminal according to an embodiment of the present disclosure; and

FIG. 9 illustrates a base station according to an embodiment of the present disclosure.

Throughout the drawings, like reference numerals will be understood to refer to like parts, components, and structures.

### DETAILED DESCRIPTION

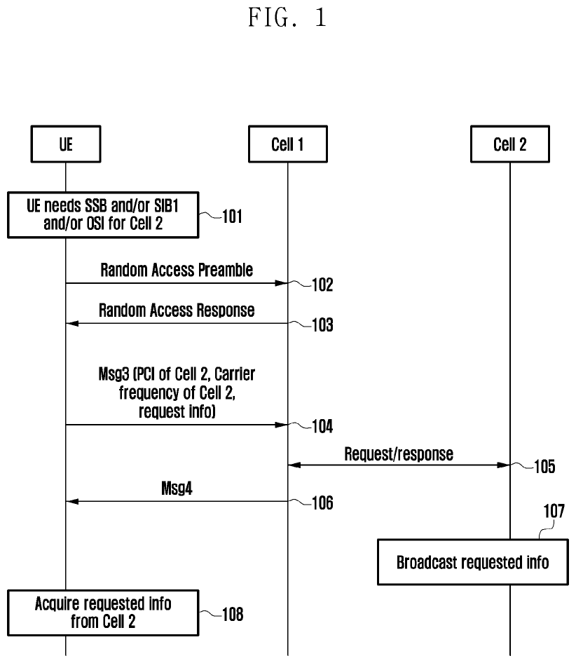

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions or may correspond to a part thereof. In some cases, functions described by blocks may be executed in an order different from the listed order. For example, two blocks listed in sequence may be executed at the same time or executed in reverse order.

In this description, the words “unit,” “module” or the like may refer to a software component or hardware component, such as, for example, a field-programmable gate array (FPGA) or an application-specific integrated circuit (ASIC) capable of carrying out a function or an operation. However, a “unit,” or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

In the recent years, several broadband wireless technologies have been developed to meet the growing number of broadband subscribers and to provide more and better applications and services. The second-generation wireless communication system has been developed to provide voice services while ensuring the mobility of users. Third generation wireless communication system supports not only the voice service but also data service. In recent years, the fourth wireless communication system has been developed to provide high-speed data service. However, currently, the 4G wireless communication system suffers from lack of resources to meet the growing demand for high speed data services. So 5G wireless communication system (also referred as next generation radio or NR) is being developed to meet the growing demand for high speed data services, support ultra-reliability and low latency applications.

The 5G wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive multiple-input multiple-output (MIMO), full dimensional MIMO (FD-MIMO), array antenna, an analog beam forming, large scale antenna techniques are being considered in the design of 5G wireless communication system. In addition, the 5G wireless communication system is expected to address different use cases having quite different requirements in terms of data rate, latency, reliability, mobility etc. However, it is expected that the design of the air-interface of the 5G wireless communication system would be flexible enough to serve the UEs having quite different capabilities depending on the use case and market segment the UE cater service to the end customer.

Few example use cases the 5G wireless communication system wireless system is expected to address is enhanced mobile broadband (eMBB), massive machine type communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the 5G wireless communication system operating in higher frequency (mmWave) bands, a UE and a gNB communicate with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into transmission (TX) beamforming performed in a transmitting end and reception (RX) beamforming performed in a receiving end.

In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array.

The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The 5G wireless communication system, supports standalone mode of operation as well dual connectivity (DC). In DC a multiple Rx/Tx UE may be configured to utilize resources provided by two different nodes (or NBs) connected via non-ideal backhaul. One node acts as the master node (MN) and the other as the Secondary Node (SN). The MN and SN are connected via a network interface and at least the MN is connected to the core network. NR also supports multi-RAT dual connectivity (MR-DC) operation whereby a UE in RRC_CONNECTED is configured to utilize radio resources provided by two distinct schedulers, located in two different nodes connected via a non-ideal backhaul and providing either E-UTRA (i.e., if the node is an ng-eNB) or NR access (i.e., if the node is a gNB).

In NR, for a UE in RRC_CONNECTED not configured with CA/DC there is only one serving cell comprising of the primary cell. For a UE in RRC_CONNECTED configured with CA/DC the term “serving cells” is used to denote the set of cells comprising of the special cell(s) and all secondary cells. In NR, the term master cell group (MCG) refers to a group of serving cells associated with the master node, comprising of the PCell and optionally one or more SCells. In NR the term secondary cell group (SCG) refers to a group of serving cells associated with the secondary node, comprising of the PSCell and optionally one or more SCells.

In NR primary cell (PCell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of special cell. Primary SCG cell (PSCell) refers to a serving cell in SCG in which the UE performs random access when performing the reconfiguration with sync procedure. For dual connectivity operation the term SpCell (i.e., special cell) refers to the PCell of the MCG or the PSCell of the SCG, otherwise the term special cell refers to the PCell.

System information acquisition in 5G wireless communication system: In the 5G wireless communication system, node B (gNB) or base station in cell broadcast synchronization signal and PBCH block (SSB) consists of primary and secondary synchronization signals (PSS, SSS) and system information. System information includes common parameters needed to communicate in cell. In the 5G wireless communication system (also referred as next generation radio or NR), system information (SI) is divided into the MIB and a number of SIBs where:

the MIB is always transmitted on the BCH with a periodicity of 80 ms and repetitions made within 80 ms and the MIB includes parameters that are needed to acquire SIB1 from the cell.

The SIB1 is transmitted on the DL-SCH with a periodicity of 160 ms and variable transmission repetition. The default transmission repetition periodicity of SIB1 is 20 ms but the actual transmission repetition periodicity is up to network implementation. The scheduling information in SIB 1 includes mapping between SIBs and SI messages, periodicity of each SI message and SI window length. The scheduling information in SIB 1 includes an indicator for each SI message, which indicates whether the concerned SI message is being broadcasted or not. If at least one SI message is not being broadcasted, SIB1 may include random access resources (PRACH preamble(s) and PRACH resource(s)) for requesting gNB to broadcast one or more SI message(s).

SIBs other than SIB1 are carried in system information (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID.

A UE acquires SIB 1 from the camped or serving cell. A UE checks the BroadcastStatus bit in SIB 1 for SI message which the UE needs to acquire. SI request configuration for SUL is signaled by a gNB using the IE si-RequestConfigSUL in SIB1. If the IE si-RequestConfigSUL is not present in SIB1, the UE considers that SI request configuration for SUL is not signaled by the gNB. SI request configuration for NUL is signaled by the gNB using the IE si-RequestConfig in SIB1. If the IE si-RequestConfig is not present in SIB1, the UE considers that SI request configuration for NUL is not signaled by the gNB. If SI message which the UE needs to acquire is not being broadcasted (i.e., BroadcastStatus bit is set to zero), the UE initiates transmission of SI request. The procedure for SI request transmission is as follows:

If an SI request configuration is signaled by a gNB for SUL, and criteria to select SUL is met (i.e., RSRP derived from SSB measurements of camped or serving cell <rsrp-ThresholdSSB-SUL, where rsrp-ThresholdSSB-SUL is signaled by the gNB (e.g., in broadcast signaling such as SIB1)): a UE initiate transmission of SI request based on Msg1 based SI request on SUL. In other words, a UE initiates random access procedure using the PRACH preamble(s) and PRACH resource(s) in SI request configuration of SUL. The UE transmits Msg1 (i.e., random access preamble) and waits for acknowledgement for SI request. Random access resources (PRACH preamble(s) and PRACH occasions(s)) indicated in SI request configuration of SUL is used for Msg1. Msg1 is transmitted on SUL. If acknowledgement for SI request is received, the UE monitors the SI window of the requested SI message in one or more SI period(s) of that SI message.

Else if SI request configuration is signaled by a gNB for NUL and criteria to select NUL is met (i.e., NUL is selected if SUL is supported in camped or serving cell and RSRP derived from SSB measurements of camped or serving cell >=rsrp-ThresholdSSB-SUL; OR NUL is selected if SUL is not supported in serving cell): a UE initiate transmission of SI request based on Msg1 based SI request on NUL (350). In other words, the UE initiates random access procedure using the PRACH preamble(s) and PRACH resource(s) in SI request configuration of NUL. The UE transmits Msg1 (i.e., random access preamble) and waits for acknowledgement for SI request. Random access resources (PRACH preamble(s) and PRACH occasions(s)) indicated in SI request configuration of NUL is used for Msg1. Msg1 is transmitted on NUL. If acknowledgement for SI request is received, the UE monitors the SI window of the requested SI message in one or more SI period(s) of that SI message.

Else the UE initiates a transmission of SI request based on Msg3 based SI request. In other words, the UE initiate transmission of RRCSystemInfoRequest message (345). The UE transmits Msg1 (i.e., random access preamble) and waits for random access response. Common random access resources (PRACH preamble(s) and PRACH occasions(s)) are used for Msg1. In the UL grant received in random access response, the UE transmits RRCSystemInfoRequest message and waits for acknowledgement for SI request (i.e., RRCSystemInfoRequest message). If acknowledgement for SI request (i.e., RRCSystemInfoRequest message) is received, the UE monitors the SI window of the requested SI message in one or more SI period(s) of that SI message.

Note that if SUL is configured, UL carrier for Msg1 transmission may be selected by the UE in similar manner as selected by the UE for Msg1 based SI request. SUL is the selected UL carrier, if RSRP derived from SSB measurements of camped or serving cell <rsrp-ThresholdSSB-SUL where rsrp-ThresholdSSB-SUL is signaled by the gNB (e.g., in broadcast signaling such as SIB1). NUL is the selected UL carrier, if RSRP derived from SSB measurements of camped or serving cell >=rsrp-ThresholdSSB-SUL where rsrp-ThresholdSSB-SUL is signaled by the gNB (e.g., in broadcast signaling such as SIB1).

PDCCH in 5G wireless communication system: In the 5G wireless communication system, physical downlink control channel (PDCCH) is used to schedule DL transmissions on PDSCH and UL transmissions on PUSCH, where the downlink control information (DCI) on PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH.

In addition to scheduling, PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; initiating a random access procedure.

A UE monitors a set of PDCCH candidates in the configured monitoring occasions in one or more configured control resource sets (CORESETs) according to the corresponding search space configurations. A CORESET consists of a set of PRBs with a time duration of 1 to 3 OFDM symbols. The resource units resource element groups (REGs) and control channel elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In 5G wireless communication system, a list of search space configurations is signaled by a GNB for each configured BWP wherein each search configuration is uniquely identified by an identifier. Identifier of search space configuration to be used for specific purpose such as paging reception, SI reception, random access response reception is explicitly signaled by a gNB. In NR, search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots “x” to x+duration where the slot with number “x” in a radio frame with number “y” satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations is signaled by a GNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depending on radio frame for each supported SCS are pre-defined in NR. Each coreset configuration is associated with a list of transmission configuration indicator (TCI) states. One DL RS ID (SSB or CSI RS) is configured per TCI state. The list of TCI states corresponding to a coreset configuration is signaled by a gNB via RRC signaling.

One of the TCI state in TCI state list is activated and indicated to a UE by a gNB via MAC CE. TCI state indicates the DL TX beam (DL TX beam is QCLed with SSB/CSI RS of TCI state) used by a GNB for transmission of PDCCH in the PDCCH monitoring occasions of a search space. For PDSCH, TCI state of scheduling PDCCH can be used for scheduled PDSCH. Alternately, TCI state of the PDCCH for the lowest corset ID in the slot is used for PDSCH. Alternately combination of RRC+MAC CE+DCI is used to indicate the TCI state for PDSCH. RRC configures a list of TCI state, MAC CE indicates a subset of these TCI states and DCI indicates one of the TCI state from list of TCI states indicated in MAC CE.

Bandwidth adaptation in 5G wireless communication system: In 5G wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a bandwidth part (BWP). BA is achieved by configuring RRC connected UE with BWP(s) and telling the UE which of the configured BWPs is currently the active one.

When BA is configured, the UE only monitor PDCCH on the one active BWP i.e., the UE may not monitor PDCCH on the entire DL frequency of the serving cell. In RRC connected state, the UE is configured with one or more DL and UL BWPs, for each configured serving cell (i.e., PCell or SCell). For an activated serving cell, there is always one active UL and DL BWP at any point in time. The BWP switching for a serving cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of random access procedure.

Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a serving cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in 5G wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state. Several types of random access procedure is supported.

Contention based random access (CBRA): this is also referred as 4 step CBRA. In this type of random access, a UE first transmits random access preamble (also referred as Msg1) and then waits for random access response (RAR) in the RAR window. RAR is also referred as Msg2. A next generation node B (gNB) transmits the RAR on physical downlink shared channel (PDSCH). PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by a gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

Several RARs for various random access preambles detected by the gNB can be multiplexed in the same RAR media access control (MAC) protocol data unit (PDU) by the gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and the UE has not yet transmitted the RA preamble for a configurable (configured by the gNB in RACH configuration) number of times, the UE goes back to first step i.e., select random access resource (preamble/RACH occasion) and transmits the RA preamble. A backoff may be applied before going back to first step.

If the RAR corresponding to its RA preamble transmission is received, the UE transmits message 3 (Msg3) in UL grant received in RAR. Msg3 includes message such as an RRC connection request, an RRC connection re-establishment request, an RRC handover confirm, a scheduling request, an SI request etc. The message may include the UE identity (i.e., cell-radio network temporary identifier (C-RNTI) or system architecture evolution (SAE)-temporary mobile subscriber identity (S-TMSI) or a random number).

After transmitting the Msg3, the UE starts a contention resolution timer. While the contention resolution timer is running, if the UE receives a physical downlink control channel (PDCCH) addressed to C-RNTI included in Msg3, contention resolution is considered successful, contention resolution timer is stopped, and RA procedure is completed. While the contention resolution timer is running, if the UE receives contention resolution MAC control element (CE) including the UE's contention resolution identity (first X bits of common control channel (CCCH) service data unit (SDU) transmitted in Msg3), contention resolution is considered successful, contention resolution timer is stopped, and RA procedure is completed. If the contention resolution timer expires and the UE has not yet transmitted the RA preamble for a configurable number of times, the UE goes back to first step i.e., select random access resource (preamble/RACH occasion) and transmits the RA preamble. A backoff may be applied before going back to first step.

Contention free random access (CFRA): this is also referred as legacy CFRA or 4 step CFRA. CFRA procedure is used for scenarios such as handover where low latency is required, timing advance establishment for secondary cell (Scell), etc. evolved node B (eNB) assigns to a UE dedicated random access preamble. The UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to contention based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and the UE has not yet transmitted the RA preamble for a configurable (configured by a gNB in a RACH configuration) number of times, the UE retransmits the RA preamble.

For certain events such has handover and beam failure recovery if dedicated preamble(s) are assigned to a UE, during first step of random access i.e., during random access resource selection for Msg1 transmission, the UE determines whether to transmit dedicated preamble or non-dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/Ros) are provided by a gNB, the UE selects a non-dedicated preamble. Otherwise, the UE selects dedicated preamble. So, during the RA procedure, one random access attempt can be CFRA while other random access attempt can be CBRA.

2 step contention based random access (2 step CBRA): In the first step, a UE transmits random access preamble on PRACH and a payload (i.e., MAC PDU) on PUSCH. The random access preamble and payload transmission is also referred as MsgA. In the second step, after MsgA transmission, the UE monitors for a response from the network (i.e., gNB) within a configured window. The response is also referred as MsgB. A next generation node B (gNB) transmits the MsgB on physical downlink shared channel (PDSCH). PDCCH scheduling the PDSCH carrying MsgB is addressed to MsgB-radio network temporary identifier (MSGB-RNTI).

MSGB-RNTI identifies the time-frequency resource (also referred as physical RA channel (PRACH) occasion or PRACH transmission (TX) occasion or RA channel (RACH) occasion) in which RA preamble was detected by a gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If CCCH SDU was transmitted in MsgA payload, a UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if the UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA.

If the fallback information is received, the UE transmits Msg3 and performs contention resolution using Msg4 as in CBRA procedure. If contention resolution is successful, random access procedure is considered successfully completed. If contention resolution fails upon fallback (i.e., upon transmitting Msg3), the UE retransmits MsgA. If configured window in which the UE monitors network response after transmitting MsgA expires and the UE has not received MsgB including contention resolution information or fallback information as explained above, the UE retransmits MsgA. If the random access procedure is not successfully completed even after transmitting the MsgA configurable number of times, the UE fallbacks to 4 step RACH procedure i.e., the UE only transmits the PRACH preamble.

A MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. MsgA may include a UE ID (e.g., random ID, S-TMSI, C-RNTI, resume ID, etc.) along with preamble in first step. The UE ID may be included in the MAC PDU of the MsgA. A UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc.

The UE ID can be different in different scenarios in which a UE performs the RA procedure. When UE performs RA after power on (before the UE is attached to the network), then the UE ID is the random ID. When the UE performs RA in an IDLE state after the UE is attached to network, the UE ID is S-TMSI. If the UE has an assigned C-RNTI (e.g., in connected state), the UE ID is C-RNTI. In case that a UE is in an INACTIVE state, the UE ID is a resume ID. In addition to the UE ID, some addition ctrl information can be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case, a gNB assigns to a UE dedicated random access preamble (s) and PUSCH resource(s) for MsgA transmission. RO(s) to be used for preamble transmission may also be indicated. In the first step, the UE transmits random access preamble on PRACH and a payload on PUSCH using the contention free random access resources (i.e., dedicated preamble/PUSCH resource/RO). In the second step, after MsgA transmission, the UE monitors for a response from the network (i.e., gNB) within a configured window. The response is also referred as MsgB.

A next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by a gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where a UE has transmitted Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If a UE receives PDCCH addressed to C-RNTI, random access procedure is considered successfully completed. If the UE receives fallback information corresponding to its transmitted preamble, random access procedure is considered successfully completed.

For certain events such has handover and beam failure recovery if dedicated preamble(s) and PUSCH resource(s) are assigned to a UE, during first step of random access i.e., during random access resource selection for MsgA transmission the UE determines whether to transmit dedicated preamble or non-dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by a gNB, a UE select non dedicated preamble. Otherwise, the UE selects dedicated preamble. So, during the RA procedure, one random access attempt can be 2 step CFRA while other random access attempts can be 2 step CBRA.

Upon initiation of random access procedure, a UE first selects the carrier (SUL or NUL). If the carrier to use for the random access procedure is explicitly signalled by a gNB, the UE select the signalled carrier for performing random access procedure. If the carrier to use for the random access procedure is not explicitly signalled by the gNB; and if the serving cell for the random access procedure is configured with supplementary uplink and if the RSRP of the downlink pathloss reference is less than rsrp-ThresholdSSB-SUL: the UE selects the SUL carrier for performing random access procedure. Otherwise, the UE selects the NUL carrier for performing random access procedure. Upon selecting the UL carrier, the UE determines the UL and DL BWP for random access procedure as specified in TS 38.321. The UE then determines whether to perform 2 step or 4 step RACH for this random access procedure.
If this random access procedure is initiated by PDCCH order and if the ra-PreambleIndex explicitly provided by PDCCH is not 0b000000, a UE selects 4 step RACH.
else if 2 step contention free random access resources are signaled by a gNB for this random access procedure, the UE selects 2 step RACH.
else if 4 step contention free random access resources are signaled by the gNB for this random access procedure, the UE selects 4 step RACH.
else if the UL BWP selected for this random access procedure is configured with only 2 step RACH resources, the UE selects 2 step RACH.
else if the UL BWP selected for this random access procedure is configured with only 4 step RACH resources, the UE selects 4 step RACH.
else if the UL BWP selected for this random access procedure is configured with both 2 step and 4 step RACH resources,
   if RSRP of the downlink pathloss reference is below a configured threshold, the UE selects 4 step RACH.
   Otherwise, the UE selects 2 step RACH.

FIG. 1 illustrates a procedure for acquisition of system information according to an embodiment of the present disclosure.

Referring to FIG. 1, a UE may be camped on a serving cell (e.g., Cell 1) on a carrier frequency (e.g., F1). The UE in RRC_IDLE/RRC_INACTIVE may intend to perform a connection setup/resume procedure for another serving cell (e.g., Cell 2) on a carrier frequency (e.g., F2) which may be same or different from the carrier frequency F1.

In operation 101, the UE may need broadcast information (e.g., SSB and/or SIB1 and/or OSI) for Cell 2. The OSI may be one or more SIBs other than a MIB and SIB1. The SSB may include PSS/SSS and PBCH wherein the PBCH includes the MIB.

The UE may initiate a random access procedure on Cell 1. In operation 102, the UE may transmit a random access preamble on a PRACH of Cell 1. Upon transmitting the random access preamble, the UE may monitor for a random access response from Cell 1. In operation 103, the UE may receive the random access response from Cell 1, wherein the response may include a UL grant. In operation 104, the UE may transmit a Msg3 to Cell 1 using the UL grant. In the Msg3, the UE may include one or more of the following information elements: a physical cell identifier (PCI) of Cell 2; a Carrier frequency of Cell 2; and information indicating that/whether the UE needs broadcast information (e.g., SSB and/or SIB1 and/or other SIBs) for Cell 2.

The information indicating that/whether the UE needs broadcast information (e.g., SSB and/or SIB1 and/or other SIBs) for Cell 2 may be included in form of bitmap, wherein each bit of the bitmap may indicate one of PSS/SSS/MIB/SIB1/SIBx, x in SIBx can be 2, 3, 4 . . . and so on. In an embodiment, a single bit of the bitmap may be common for PSS/SSS/MIB or separate bits may indicate PSS/SSS and MIB, respectively. In an alternate embodiment, instead of bitmap, a type of information needed may be explicitly indicated. The information may be included together in an RRC message, and a MAC SDU/PDU carrying the RRC message may be included in the Msg3. The RRC message may be transmitted over signaling radio bearer 0 (SRB 0) or CCCH.

Upon receiving the Msg3, in operation 105, Cell 1 may inform the cell (i.e., Cell 2) indicated in the Msg3 about UE's request as included in the Msg3, and Cell 2 may send a response to Cell 1. Alternately, upon receiving the Msg3, in operation 105, CU/DU/gNB of Cell 1 may inform the CU/DU/gNB of cell (i.e., Cell 2) indicated in the Msg3 about UE's request as included in the Msg3, and CU/DU/gNB of Cell 2 may send a response to CU/DU/gNB of Cell 1 In operation 107, Cell 2 may start broadcasting the requested information e.g., PSS/SSS/MIB/SIB1/Other SIB(s). This broadcast transmission by Cell 2 may be performed for limited time duration which can be fixed or configured by the network. In operation 106, Cell 1 may also transmit a Msg 4 or acknowledgment (ACK) for the Msg3 to the UE. This Msg4 or ACK may be transmitted after receiving the response from Cell 2 or may be transmitted before receiving the response from Cell 2.

In response to the Msg3, the UE may receive the Msg4 or ACK for the UE's request transmitted in the Msg3. The Msg4/ack may be a MAC PDU including contention resolution identity MAC CE, wherein the contention resolution identity may be the CCCH SDU or part (e.g., first X bits of CCCH SDU, where X can be 48 bits or any other number of bits) of CCCH SDU transmitted by the UE in the Msg3. In operation 108, upon receiving the Msg4/ack, the UE may receive/acquire the requested information from Cell 2, by monitoring downlink (or downlink carrier) of Cell 2.

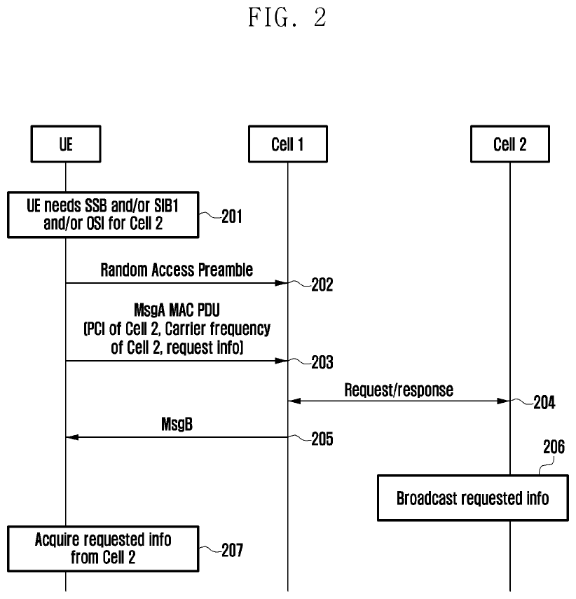

FIG. 2 illustrates a procedure for acquisition of system information according to an embodiment of the present disclosure.

Referring to FIG. 2, a UE may be camped on a serving cell (e.g., Cell 1) on a carrier frequency (e.g., F1). The UE in RRC_IDLE/RRC_INACTIVE may intend to perform a connection setup/resume procedure for another serving cell (e.g., Cell 2) on a carrier frequency F2 which may be same or different from the carrier frequency F1.

In operation 201, the UE may need broadcast information (e.g., SSB and/or SIB1 and/or OSI) for Cell 2. The OSI may be one or more SIBs other than a MIB and SIB1. The SSB may include PSS/SSS and PBCH wherein the PBCH includes the MIB.

The UE may initiate a 2-step random access procedure on Cell 1 by transmitting a Msg A. In operation 202, the UE may transmit a random access preamble on a PRACH of Cell 1. In operation 202, the UE may transmit MsgA MAC PDU to Cell 1. In an embodiment of FIG. 2, instead of Msg3, the UE may include, in the MsgA MAC PDU, one or more of the following information elements: a physical cell identifier (PCI) of Cell 2; a Carrier frequency of Cell 2; information indicating that/whether the UE needs broadcast information (e.g., SSB and/or SIB1 and/or other SIBs) from Cell 2. Descriptions of the above information elements can be referred to as described in operation 104 of FIG. 1.

Upon receiving MsgA, in operation 204, Cell 1 may inform Cell 2 about UE's request as included in the MsgA, and Cell 2 may send a response to Cell 1. Alternately, upon receiving MsgA, in operation 204, CU/DU/gNB of Cell 1 may inform CU/DU/gNB of Cell 2 about UE's request as included in the MsgA, and CU/DU/gNB of Cell 2 may send a response to CU/DU/gNB of Cell 1. In operation 206, Cell 2 may start broadcasting the requested information e.g., PSS/SSS/MIB/SIB1/Other SIB(s). This broadcast transmission by Cell 2 may be performed for limited time duration which can be fixed or configured by the network. In operation 205, Cell 1 may also transmit MsgB or an acknowledgment (ACK) for the MsgA to the UE. This MsgB or ACK can be transmitted after receiving the response from Cell 2 or may be transmitted before receiving the response from Cell 2.

Upon receiving MsgB/ACK, in operation 207, the UE may receive/acquire the requested information from Cell 2, by monitoring downlink (or downlink carrier) of Cell 2. The MsgB/ACK may be a MAC PDU including contention resolution identity MAC CE, wherein the contention resolution identity may be the CCCH SDU or part (e.g., first X bits of CCCH SDU, where X can be 48 bits or any other number of bits) of CCCH SDU transmitted by the UE in the MsgA MAC PDU.

In an alternate embodiment, upon receiving the UE's request in MsgA or Msg3, Cell 1 may broadcast the requested information (e.g., MIB, SIB1, and other SIB) of Cell 2. Cell 1 (or CU/DU/gNB of Cell 1) may request (over Xn interface) the information from Cell 2 (or CU/DU/gNB of Cell 2). Upon reception of such information from Cell 2 (or CU/DU/gNB of Cell 2), Cell 1 (or CU/DU/gNB of Cell 1) may broadcast the information over downlink (or downlink carrier) of Cell 1. In this case, upon receiving MsgB/Msg4/ack, the UE may receive/acquire the requested information from Cell 1, by monitoring downlink (or downlink carrier) of Cell 1.

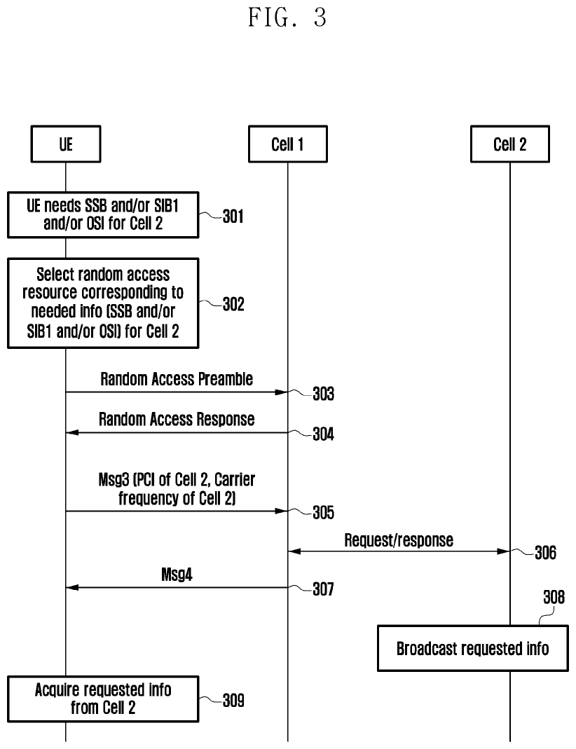

FIG. 3 illustrates a procedure for acquisition of system information according to an embodiment of the present disclosure.

Referring to FIG. 3, a UE may be camped on a serving cell (e.g., Cell 1) on a carrier frequency (e.g., F1). The UE in RRC_IDLE/RRC_INACTIVE may intend to perform a connection setup/resume procedure for another serving cell (e.g., Cell 2) on a carrier frequency F2 which may be same or different from the carrier frequency F1.

In operation 301, the UE may need broadcast information (e.g., SSB and/or SIB1 and/or OSI) for Cell 2. The OSI may be one or more SIBs other than a MIB and SIB1. The SSB may include PSS/SSS and PBCH wherein the PBCH includes the MIB.

The UE may initiate a random access procedure on Cell 1. In operation 302, depending on whether the UE needs the broadcast information (SSB and/or SIB1 and/or OSI) for Cell 2, the UE may select appropriate/corresponding RACH resource (preamble and/or RO). Cell 1 may broadcast mapping between RACH resource (preamble and/or RO) and SSB/SIB1/OSI (or PSS/SSS/MIB/SIB1/other SIBs). In operation 303, the UE may transmit a random access preamble to Cell 1 using the selected RACH resource. Upon transmitting the random access preamble, the UE may monitor for a random access response from Cell 1. In operation 304, the UE may receive the random access response from Cell 1, wherein the response may include a UL grant. In operation 305, the UE may transmit a Msg3 to Cell 1 using the UL grant.

In the Msg3, the UE may include one or more of the following information elements: a PCI of Cell 2; and a Carrier frequency of Cell 2. The information may be included together in an RRC message, and a MAC SDU carrying the RRC message may be included in the Msg3. The RRC message may be transmitted over SRB 0 or CCCH. Alternatively, I information may also be included together in a MAC CE. Note that whether the UE needs broadcast information (e.g., SSB and/or SIB1 and/or other SIBs) for Cell 2 is indicated by the random access preamble transmission.

Upon receiving the Msg3, in operation 306, Cell 1 (or CU/DU/gNB of Cell 1) may inform Cell 2 (or CU/DU/gNB of Cell 2) about UE's request as indicated by Msg1, and Cell 2 (or CU/DU/gNB of Cell 2) may send a response to Cell 1 (or CU/DU/gNB of Cell 1). In operation 308, Cell 2 may start broadcasting the requested information e.g., PSS/SSS/MIB/SIB1/Other SIB(s). This broadcast transmission by Cell 2 may be performed for limited time duration which can be fixed or configured by the network. In operation 307, Cell 1 may also transmit a Msg4 or an acknowledgement (ACK) for the Msg3 to the UE. This Msg4 or ACK may be transmitted after receiving the response from Cell 2 or may be transmitted before receiving the response from Cell 2.

In response to the Msg3, the UE may receive the Msg4 or ACK for the UE's request transmitted in the Msg3. The Msg4/ack may be a MAC PDU including contention resolution identity MAC CE, wherein the contention resolution identity may be the CCCH SDU or part (e.g., first X bits of CCCH SDU, where X can be 48 bits or any other number of bits) of CCCH SDU transmitted by the UE in the Msg3. In operation 309, upon receiving the Msg4/ack, the UE may receive/acquire the requested information from Cell 2, by monitoring downlink (or downlink carrier) of Cell 2.

In an alternate embodiment, the UE may initiate a 2-step random access procedure on Cell 1 by transmitting a Msg A. Depending on whether the UE needs the broadcast information (SSB and/or SIB1 and/or OSI) for Cell 2, the UE may select appropriate RACH resource (preamble and/or RO). Cell 1 may broadcast mapping between RACH resource (preamble and/or RO) and SSB/SIB1/OSI (or PSS/SSS/MIB/SIB1/other SIBs). The UE may transmit a random access preamble Cell 1 using the selected RACH resource. The UE may transmit PCI and/or Carrer Frequency of Cell 2 in the MsgA MAC PDU, instead of Msg3. Upon receiving MsgA, Cell 1 (or CU/DU/gNB of Cell 1) may inform Cell 2 (or CU/DU/gNB of Cell 2) about UE's request as indicated by the random access preamble, and Cell 2 (or CU/DU/gNB of Cell 2) may send a response to Cell 1 (or CU/DU/gNB of Cell 1). Cell 2 may start broadcasting the requested information e.g., PSS/SSS/MIB/SIB1/Other SIB(s). This broadcast transmission by Cell 2 may be performed for limited time duration which can be fixed or configured by the network. Cell 1 may also transmit MsgB or an acknowledgment (ACK) for the MsgA to the UE. This MsgB or ACK may be transmitted after receiving the response from Cell 2 or may be transmitted before the response from Cell 2.

Upon receiving MsgB/ACK, the UE may receive/acquire the requested information from Cell 2, by monitoring downlink (or downlink carrier) of Cell 2. The MsgB/ACK may be a MAC PDU including contention resolution identity MAC CE, wherein the contention resolution identity may be the CCCH SDU or part (e.g., first X bits of CCCH SDU, where X can be 48 bits or any other number of bits) of CCCH SDU transmitted by the UE in the MsgA MAC PDU.

In an alternate embodiment, upon receiving the UE's request in MsgA or Msg3, Cell 1 may broadcast the requested information (e.g., MIB, SIB1, and other SIB) of Cell 2. Cell 1 (or CU/DU/gNB of Cell 1) may request (over Xn interface) the information from Cell 2 (or CU/DU/gNB of Cell 2). Upon reception of such information from Cell 2 (or CU/DU/gNB of Cell 2), Cell 1 (or CU/DU/gNB of Cell 1) may broadcast the information over downlink (or downlink carrier) of Cell 1. In this case, upon receiving MsgB/Msg4/ack, the UE may receive/acquire the requested information from Cell 1, by monitoring downlink (or downlink carrier) of Cell 1.

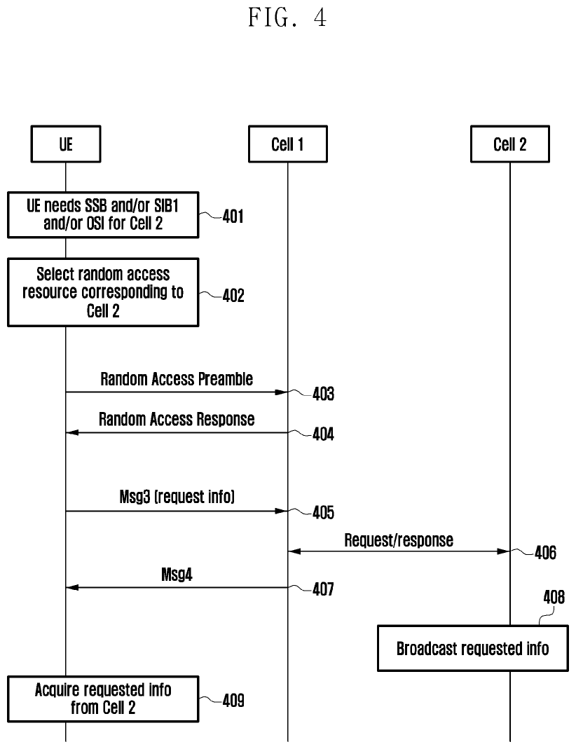

FIG. 4 illustrates a procedure for acquisition of system information according to an embodiment of the present disclosure.

Referring to FIG. 4, a UE may camp on a serving cell (e.g., Cell 1) on a carrier frequency (e.g., F1). The UE in RRC_IDLE/RRC_INACTIVE may intend to perform a connection setup/resume procedure for another serving cell (e.g., Cell 2) on a carrier frequency F2 which may be same or different from carrier frequency F1.

In operation 401, the UE may need broadcast information (e.g., SSB and/or SIB1 and/or OSI) for Cell 2. The OSI may be one or more SIBs other than a MIB and SIB1. The SSB may include PSS/SSS and PBCH wherein the PBCH includes the MIB.

The UE may initiate a random access procedure on Cell 1. In operation 402, depending on cell whose broadcast information (SSB and/or SIB1 and/or OSI) the UE needs, the UE may select appropriate/corresponding RACH resource (preamble and/or RO). Cell 1 may broadcast mapping between RACH resource (preamble and/or RO) and cell(s). In operation 403, the UE may transmit a random access preamble to Cell 1 using the selected RACH resource. Upon transmitting the random access preamble, the UE may monitor for a random access response from Cell 1. In operation 404, the UE may receive the random access response from Cell 1, wherein the response may include a UL grant.

In operation 405, the UE may transmit a Msg3 to Cell 1 using the UL grant. In the Msg3, the UE may include information indicating that/whether the UE needs broadcast information (SSB and/or SIB1 and/or other SIBs). The information indicating that/whether the UE needs broadcast information (e.g., SSB and/or SIB1 and/or other SIBs) for Cell 2 may be included in form of bitmap, wherein each bit of the bitmap may indicate one of PSS/SSS/MIB/SIB1/SIBx. In an embodiment, a single bit of the bitmap may be common for PSS/SSS/MIB or separate bits may indicate PSS/SSS and MIB, respectively. In an alternate embodiment, instead of bitmap, a type of information needed may be explicitly indicated. The information may be included together in an RRC message, and a MAC SDU carrying the RRC message may be included in the Msg3. The RRC message may be transmitted over SRB 0 or CCCH. The information may also be included together in a MAC CE. Note that the cell for which the UE needs broadcast information (SSB and/or SIB1 and/or other SIBs) is indicated by the random access preamble transmission.

Upon receiving the Msg3, in operation 406, Cell 1 (or CU/DU/gNB of Cell 1) may inform Cell 2 (or CU/DU/gNB of Cell 2) (as indicated by Msg1) about UE's request as indicated by Msg3, and Cell 2 (or CU/DU/gNB of Cell 2) may send a response to Cell 1 (or CU/DU/gNB of Cell 1). In operation 408, Cell 2 may start broadcasting the requested information e.g., PSS/SSS/MIB/SIB1/Other SIB(s). This broadcast transmission by Cell 2 may be performed for limited time duration which can be fixed or configured by the network. Cell 1 may also transmit a Msg4 or an acknowledgement (ACK) for the Msg3 to the UE. This Msg4 or ACK may be transmitted after receiving the response from Cell 2 or may be transmitted before receiving the response from Cell 2.

In response to the Msg3, the UE may receive the Msg4 or ACK for the UE's request transmitted in the Msg3. The Msg4/ack may be a MAC PDU including contention resolution identity MAC CE, wherein the contention resolution identity may be the CCCH SDU or part (e.g., first X bits of CCCH SDU, where X can be 48 bits or any other number of bits) of CCCH SDU transmitted by the UE in the Msg3. In operation 409, upon receiving the Msg4/ack, the UE may receive/acquire the requested information from Cell 2, by monitoring downlink (or downlink carrier) of Cell 2.

In an alternate embodiment, the UE may initiate a 2-step random access procedure on Cell 1 by transmitting a Msg A. Depending on cell whose broadcast information (SSB and/or SIB1 and/or OSI) the UE needs, the UE may select appropriate RACH resource (preamble and/or RO). Cell 1 may broadcast mapping between RACH resource (preamble and/or RO) and cell(s). The UE may transmit a random access preamble Cell 1 using the selected RACH resource. The UE may transmit, in MsgA MAC PDU, information indicating that/whether the UE needs broadcast information (SSB and/or SIB1 and/or other SIBs).

Upon receiving MsgA, Cell 1 (or CU/DU/gNB of Cell 1) may inform Cell 2 (or CU/DU/gNB of Cell 2) (as indicated by the random access preamble) about UE's request as indicated by the MsgA MAC PDU, and Cell 2 (or CU/DU/gNB of Cell 2) may send a response to Cell 1 (or CU/DU/gNB of Cell 1). Cell 2 may start broadcasting the requested information e.g., PSS/SSS/MIB/SIB1/Other SIB(s). This broadcast transmission by Cell 2 may be performed for limited time duration which can be fixed or configured by the network. Cell 1 may also transmit Msg B or an acknowledgement (ACK) for the MsgA to the UE. This MsgB or ACK may be transmitted after receiving the response from Cell 2 or may be transmitted before receiving the response from Cell 2.

Upon receiving MsgB/ACK, the UE may receive/acquire the requested information from Cell 2, by monitoring downlink (or downlink carrier) of Cell 2. The MsgB/ACK may be a MAC PDU including contention resolution identity MAC CE, wherein the contention resolution identity may have been included in the CCCH SDU or part (e.g., first X bits of CCCH SDU, where X can be 48 bits or any other number of bits) of CCCH SDU transmitted by the UE in the MsgA MAC PDU.

In an alternate embodiment, upon receiving the UE's request in MsgA or Msg3, Cell 1 (or CU/DU/gNB of Cell 2) may broadcast the requested information (e.g., MIB, SIB1, and other SIB) of Cell 2. Cell 1 (or CU/DU/gNB of Cell 1) may request (over Xn interface) the information from Cell 2 (or CU/DU/gNB of Cell 2). Upon reception of such information from Cell 2 (or CU/DU/gNB of Cell 2), Cell 1 (or CU/DU/gNB of Cell 1) may broadcast the information over downlink (or downlink carrier) of Cell 1. In this case, upon receiving MsgB/Msg4/ack, the UE may receive/acquire the requested information from Cell 1, by monitoring downlink (or downlink carrier) of Cell 1.

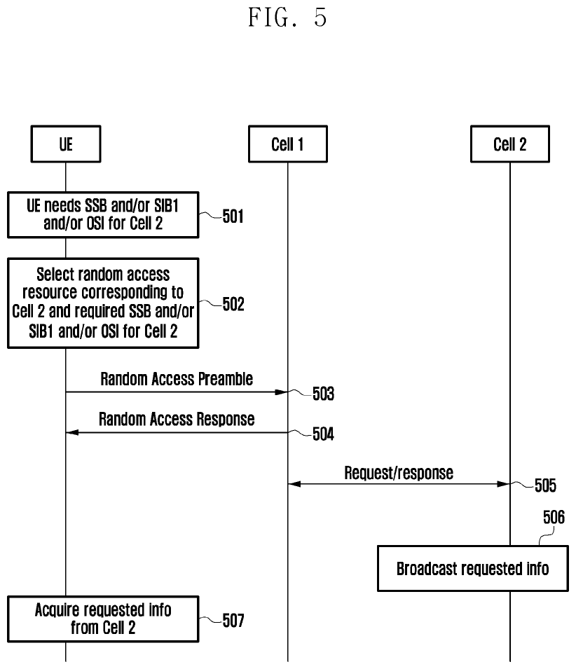

FIG. 5 illustrates a procedure for acquisition of system information according to an embodiment of the present disclosure.

Referring to FIG. 5, a UE may camp on a serving cell (e.g., Cell 1) on a carrier frequency (e.g., F1). The UE in RRC_IDLE/RRC_INACTIVE may intend to perform connection setup/resume procedure for another serving cell (e.g., Cell 2) on a carrier frequency F2 which may be same or different from carrier frequency F1.

In operation 501, the UE may need broadcast information (e.g., SSB and/or SIB1 and/or OSI) for Cell 2. The OSI may be one or more SIBs other than a MIB and SIB1. The SSB may include PSS/SSS and PBCH wherein the PBCH includes the MIB.

The UE may initiate a random access procedure on Cell 1. In operation 502, depending on the cell and type (SSB and/or SIB1 and/or OSI) of the broadcast information the UE needs, the UE may select appropriate/corresponding RACH resource (preamble and/or RO). Cell 1 may broadcast mapping between RACH resource (preamble and/or RO) and type (SSB and/or SIB1 and/or OSI) of the broadcast information for other cells. In operation 503, the UE may transmit a random access preamble Cell 1 using the selected RACH resource. Upon transmitting the random access preamble, the UE may monitor for a random access response from Cell 1. In operation 504, the UE may receive the random access response from Cell 1, wherein the response includes an acknowledgement (ACK) for the UE's request. Note that the cell for which the UE needs broadcast information (SSB and/or SIB1 and/or other SIBs) and the type of the broadcast information is indicated by the random access preamble transmission.

Upon receiving the Msg1, in operation 505, Cell 1 (or CU/DU/gNB of Cell 1) may inform Cell 2 (or CU/DU/gNB of Cell 2) (as indicated by Msg1) about UE's request as indicated by Msg1 and Cell 2 (or CU/DU/gNB of Cell 2) may send a response to Cell 1 (or CU/DU/gNB of Cell 1). In operation 506, Cell 2 may start broadcasting the requested information e.g., PSS/SSS/MIB/SIB1/Other SIB(s). This broadcast transmission by Cell 2 may be performed for limited time duration which can be fixed or configured by the network. Cell 1 may also transmit a Msg2 or ACK for the Msg1 to the UE. This Msg2 or ACK may be transmitted after receiving the response from Cell 2 or may be transmitted before receiving the response from Cell 2.

In response to the Msg1, the UE may receive the Msg2/ACK for the UE's request transmitted in the Msg1. In operation 507, upon receiving the Msg2/ack, the UE may receive/acquire the requested information from Cell 2, by monitoring downlink (or downlink carrier) of Cell 2.

In an alternate embodiment, upon receiving the UE's request in Msg1, Cell 1 may broadcast the requested information (e.g., MIB, SIB1, and other SIB of Cell 2. Cell 1 (or CU/DU/gNB of Cell 1) may request (over Xn interface) the information from Cell 2 (or CU/DU/gNB of Cell 2). Upon reception of such information from Cell 2 (or CU/DU/gNB of Cell 2), Cell 1 (or CU/DU/gNB of Cell 1) may broadcast the information over downlink (or downlink carrier) of Cell 1. In this case, upon receiving Msg2/ack, the UE may receive/acquire the requested information from Cell 1, by monitoring downlink (or downlink carrier) of Cell 1.

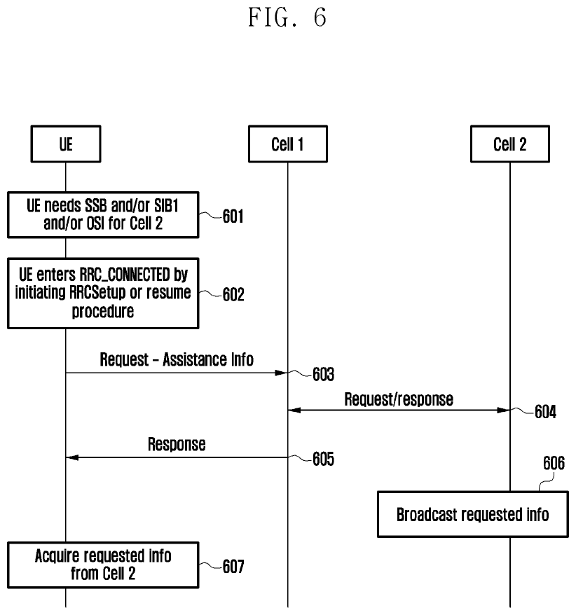

FIG. 6 illustrates a procedure for acquisition of system information according to an embodiment of the present disclosure.

Referring to FIG. 6, a UE may be camped on a serving cell (e.g., Cell 1) on a carrier frequency (e.g., F1). The UE in RRC_IDLE/RRC_INACTIVE may intend to perform a connection setup/resume procedure for another serving cell (e.g., Cell 2) on a carrier frequency F2 which may be same or different from carrier frequency F1.

In operation 601, the UE may need broadcast information (e.g., SSB and/or SIB1 and/or OSI) for Cell 2. The OSI may be one or more SIBs other than a MIB and SIB1. The SSB may include PSS/SSS and PBCH wherein the PBCH includes the MIB.

In operation 602, the UE may enter RRC_CONNECTED in the serving cell (i.e., Cell 1), if the UE is not already in RRC_CONNECTED, by initiating an RRC setup or RRC resume procedure.

In operation 603, the UE may send assistance information to Cell 1. The assistance information may indicate at least one of a PCI of Cell 2, and a Carrier frequency of Cell 2. The assistance information may further indicate that/whether the UE needs broadcast information (SSB/SIB1/Other SIBs). Note that in case there is only access cell corresponding to Cell 1, the PCI may not be needed, and the indication that/whether the UE needs broadcast information about access cell may be sufficient. The information indicating that/whether the UE needs broadcast information (PSS/SSS/MIB and/or SIB1 and/or one or more SIBs) may be included in form of bitmap, wherein each bit of the bitmap may indicate one of PSS/SSS/MIB/SIB1/SIBx.

In an embodiment, a single bit of the bitmap may be common for PSS/SSS/MIB or separate bits may indicate PSS/SSS and MIB, respectively. In an alternate embodiment, instead of bitmap, a type of information needed may be explicitly indicated. The information may be included together in an RRC message. The RRC message may be transmitted over SRB ½ or DCCH.

Upon receiving the request (assistance information) from the UE, in operation 604, Cell 1 (or CU/DU/gNB of Cell 1) may inform Cell 2 (or CU/DU/gNB of Cell 2) (as indicated by the assistance information) about the UE's request as indicated by the assistance information, and Cell 2 (or CU/DU/gNB of Cell 2) may send a response to Cell 1 (or CU/DU/gNB of Cell 2). In operation 606, the Cell 2 (or CU/DU/gNB of Cell 2) may start broadcasting the requested information e.g., PSS/SSS/MIB/SIB1/Other SIB(s). This broadcast transmission by Cell 2 (or CU/DU/gNB of Cell 2) may be performed for limited time duration which can be fixed or configured by the network. In operation 605, Cell 1 may transmit an acknowledgment (ACK) for the request received from the UE. This ACK may be transmitted after receiving the response from Cell 2 or may be transmitted before receiving the response from Cell 2.

In an alternate embodiment, upon receiving the UE's request, Cell 1 may broadcast the requested information (e.g., MIB, SIB1, and other SIB of Cell 2). Cell 1 (or CU/DU/gNB of Cell 1) may request (over Xn interface) the information from Cell 2 (or CU/DU/gNB of Cell 2). Upon reception of such information from Cell 2 (or CU/DU/gNB of Cell 2), Cell 1 (or CU/DU/gNB of Cell 1) may broadcast the information over downlink (or downlink carrier) of Cell 1. In this case, upon receiving ack or upon transmitting request, the UE may receive/acquire the requested information from Cell 1, monitoring downlink (or downlink carrier) of Cell 1, in operation 607.

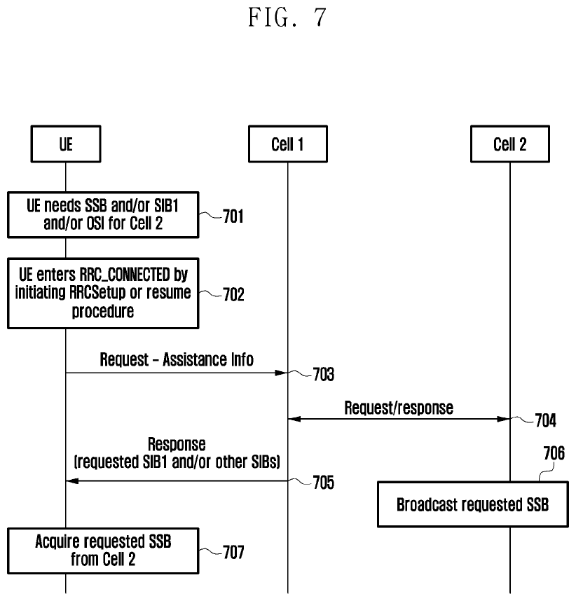

FIG. 7 illustrates a procedure for acquisition of system information according to an embodiment of the present disclosure.

Referring to FIG. 7, a UE may be camped on a serving cell (e.g., Cell 1) on a carrier frequency (e.g., F1). The UE in RRC_IDLE/RRC_INACTIVE may intend to perform a connection setup/resume procedure for another serving cell (e.g., Cell 2) on a carrier frequency F2 which may be same or different from carrier frequency F1.

In operation 701, the UE may need broadcast information (e.g., SSB and/or SIB1 and/or OSI) for Cell 2. The OSI is one or more SIBs other than a MIB and SIB1. The SSB may include PSS/SSS and PBCH wherein the PBCH includes the MIB.

In operation 702, the UE may enter RRC_CONNECTED in the serving cell (i.e., Cell 1), if the US is not already in RRC_CONNECTED, by initiating an RRC setup or RRC resume procedure.

In operation 703, the UE may send assistance information to Cell 1 The assistance information may indicate at least one of a PCI of Cell 2, and a Carrier frequency of Cell 2. The assistance information may further indicate that/whether the UE needs broadcast information (SSB/SIB1/Other SIBs). Note that in case there is only access cell corresponding to Cell 1, the PCI may not be needed, and the indication that/whether the UE needs broadcast information about access cell may be sufficient. The information indicating that/whether the UE needs broadcast information (PSS/SSS/MIB and/or SIB1 and/or one or more SIBs) may be included in form of bitmap, wherein each bit of the bitmap may indicate one of PSS/SSS/MIB/SIB1/SIBx.

In an embodiment, a single bit of the bitmap may be common for PSS/SSS/MIB or separate bits may indicate PSS/SSS and MIB, respectively. In an alternate embodiment, instead of bitmap, a type of information needed may be explicitly indicated. The information may be included together in an RRC message. The RRC message may be transmitted over SRB ½ or DCCH.

Upon receiving the request (assistance information) from the UE, in operation 704, Cell 1 (or CU/DU/gNB of Cell 1) may inform Cell 2 (or CU/DU/gNB of Cell 2) (as indicated by the assistance information) about the UE's request as indicated by the assistance information, and Cell 2 (or CU/DU/gNB of Cell 2) may send a response to Cell 1 (or CU/DU/gNB of Cell 1). and in operation 706, Cell 2 may start broadcasting the requested SSB and provide the requested SIB1 or other SIBs to Cell 1. This broadcast transmission by Cell 2 may be performed for limited time duration which can be fixed or configured by the network. Upon reception of such information from Cell 2 (or CU/DU/gNB of Cell 2), in operation 707, Cell 1 (or CU/DU/gNB of Cell 1) may transmit the information (SIB1 and/or other SIBs) over downlink (or downlink carrier) of Cell 1 in dedicated signaling to the UE. In this case the UE may receive/acquire the SSB if requested from Cell 2, by monitoring downlink (or downlink carrier) of Cell 2.

Alternatively, in another embodiment of the present disclosure, a UE may request the broadcast information by sending a RACH to Cell 2.

In one embodiment, a UE may be camped on a serving cell (e.g., Cell 1) on a carrier frequency (e.g., F1). The UE in RRC_IDLE/RRC_INACTIVE may intend to perform a connection setup/resume procedure for another serving cell (e.g., Cell 2) on a carrier frequency F2 which may be same or different from carrier frequency F1.

The UE may need broadcast information (e.g., SSB and/or SIB1 and/or OSI) for Cell 2. The OSI may be one or more SIBs other than a MIB and SIB1. The SSB may include PSS/SSS and PBCH wherein the PBCH includes the MIB.

Alt 1:
The UE may transmit a RACH on Cell 2. Depending on whether the UE needs SSB/SIB1/OSI, the UE may select appropriate RACH resource (Preamble/RO) for the RACH. The preambles/ROs for other cell's SSB/SIB1/OSI (e.g., mapping between RACH resource and SSB/SIB1/OSI) may be signaled in a SIB of Cell 1.
The DL timing (e.g., offset) of Cell 2 with respect to Cell 1 may be signaled by Cell 1 in SI
The UE may receive a SI request ack from Cell 2 in response to the Msg1

Alt 2:
The UE may transmit a RACH on Cell 2. The UE may receive a random access response (RAR) on Cell 2. The UE may transmit a Msg3 on Cell 2. The Msg3 indicates the broadcast information (e.g., SSB and/or SIB1 and/or Other SIBs) requested by the UE.
Preambles/ROs for Cell 2 may be signaled in a SIB of Cell 1.
The DL timing (e.g., offset) of Cell 2 with respect to Cell 1 may be signaled by PCell 1 in SI
The UE may receive a SI request ack from Cell 2 in response to the Msg3

Cell 2 may broadcast the requested SSB/SIB1/Other SIBs. The broadcast may be performed for specified period. Upon receiving the SI request ack, the UE may receive/acquire the requested information from Cell 2.

Note that point at which the UE initiates acquisition of SI of PCell 2, can be at the time of connection initiation or in advance.

In the methods explained earlier wherein the UE receives/acquires MIB/SIB1/OSI from Cell 2, if the UE fails to receive MIB/SIB1/OSI in Cell2, the UE may need to fall back to Cell 1 and retry the request.
For this, a timer may be started when the SI request ack is received by the UE in response to Msg3/Msg1.
If the UE receives the requested information successfully, the timer is stopped.
At the expiry of the timer, the UE may re-start sending RACH preamble to Cell 1 and increase a counter.
If the counter reaches to the maximum value, the failure may be reported to Cell 1 via UE assistance information or a new message.
A new prohibit timer may also be introduced to avoid frequent requests for other cells' SI.

In the methods explained earlier, in the request information from a UE, a separate indication for SSB, MIB and SIB1; and/or a separate indication for SSB and SIB 1; and/or a common Indication for SSB and SIB 1 may be included.

In the following, various modifications of the embodiments through FIGS. 1 to 7 are described.

For example, one or more cells in the network may transmit PSS/SSS at longer periodicity. Here, a PBCH may not be periodically transmitted.
The network may broadcast a list of PCIs of these cells through other cells. Alternately, different PSS/SSS sequences may be used for these cells.
   If the UE detects such cells, the UE may know that the UE may transmit the request for PBCH/SIB1, as the cells do not periodically transmit PBCH/SIB1.

For example, time/frequency locations for transmitting an uplink signal with respect to the location of PSS/SSS may be defined (e.g., offset, period etc.).
The time/frequency locations may be fixed or signaled by other cells.
The time/frequency locations may be in each PSS/SSS period or in some of them.

For example, upon detecting such cells, if the UE intends to access these cells, the UE may transmit an uplink signal (e.g., RACH). The RACH preamble may be pre-defined.
ROs may correspond to each beam direction. Preamble may be common for each beam.
One RO may correspond to multiple beams. Preambles may be different for different beams in a RO.
Number of beams per RO and preambles may be pre-defined or signaled by other cells.
Upon receiving the preamble, the cell may broadcast PBCH and SIB1. Alternatively, depending on the preamble received, the cell may broadcast PBCH or SIB1 or PBCH/SIB1.

For example, upon receiving SIB1, other SI may be obtained as in legacy scheme.

Meanwhile, the eXtended Reality (XR) is a term for different types of realities and refers to all real-and-virtual combined environments and human-machine interactions generated by computer technology and wearables. XR may include following representative forms and the areas interpolated among them: augmented reality (AR); mixed reality (MR); virtual reality (VR). Many of the XR use cases are characterized by quasi-periodic traffic (with possible jitter) with high data rate in DL (i.e., video steam) combined with the frequent UL (i.e., pose/control update) and/or UL video stream. Both DL and UL traffic are also characterized by relatively strict packet delay budget (PDB).

Typically for UL packet transmission to a gNB, a UE may perform HARQ transmission. If the packet is not successfully delivered, the UE may perform HARQ retransmission. For certain XR traffic such as pose/control traffic transmitted by the UE in uplink, the HARQ retransmission may not be essential, due to the packet delay budget for the traffic. Even if the gNB receives the packet after several HARQ retransmission, this packet is stale and will be discarded.

In an embodiment, a gNB may signal one or more configured grant (CG) configurations in RRCReconfiguration message. The gNB may also signal whether the UE applies drx-HARQ-RTT-TimerUL and drx-RetransmissionTimerUL or not, for UL transmissions performed based on the CG configuration. For example, the gNB may indicate if HARQ retransmission is applicable for UL transmission performed based on the CG configuration. This signaling may be performed per CG configuration.

In an embodiment, the UE may:
1> if a MAC PDU is transmitted in a configured uplink grant and LBT failure indication is not received from lower layers:
1> If HARQ retransmission is applicable for transmission in the configured UL grant (as indicated by a gNB) or drx-HARQ-RTT-TimerUL and drx-RetransmissionTimerUL are applicable for transmission in the configured UL grant (as indicated by the gNB)
   2> if drx-LastTransmissionUL is configured:
      3> start the drx-HARQ-RTT-TimerUL for the corresponding HARQ process in the first symbol after the end of the last transmission (within a bundle) of the corresponding PUSCH transmission.
   2> else:
      3> start the drx-HARQ-RTT-TimerUL for the corresponding HARQ process in the first symbol after the end of the first transmission (within a bundle) of the corresponding PUSCH transmission.
   2> stop the drx-RetransmissionTimerUL for the corresponding HARQ process at the first transmission (within a bundle) of the corresponding PUSCH transmission.

In an alternate embodiment, the gNB may signal whether the UE applies drx-HARQ-RTT-TimerUL and drx-RetransmissionTimerUL or not, for UL transmissions performed based on a HARQ process. For example, the gNB may indicate if HARQ retransmission is applicable for UL transmission performed based on the HARQ process.

In an embodiment, the UE may:
1> if a MAC PDU is transmitted in a configured uplink grant and LBT failure indication is not received from lower layers:
1> If HARQ retransmission is applicable for HARQ process corresponding to the transmission or drx-HARQ-RTT-TimerUL and drx-RetransmissionTimerUL are applicable for HARQ process corresponding to the transmission (as indicated by the gNB)
   2> if drx-LastTransmissionUL is configured:
      3> start the drx-HARQ-RTT-TimerUL for the corresponding HARQ process in the first symbol after the end of the last transmission (within a bundle) of the corresponding PUSCH transmission.
   2> else:
      3> start the drx-HARQ-RTT-TimerUL for the corresponding HARQ process in the first symbol after the end of the first transmission (within a bundle) of the corresponding PUSCH transmission.
2> stop the drx-RetransmissionTimerUL for the corresponding HARQ process at the first transmission (within a bundle) of the corresponding PUSCH transmission.

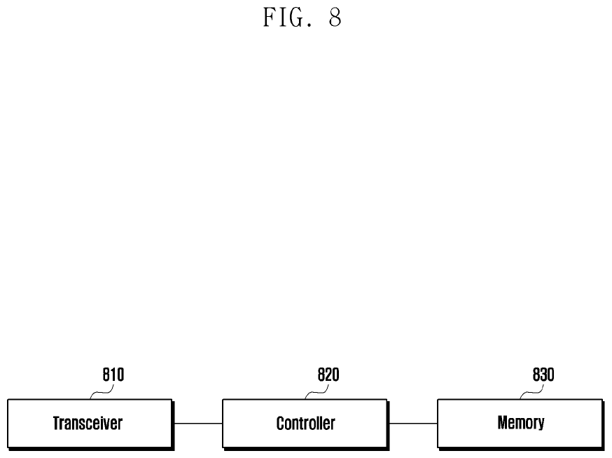

FIG. 8 illustrates a block diagram of a terminal according to an embodiment of the present disclosure.

Referring to FIG. 8, a terminal includes a transceiver 810, a controller 820 and a memory 830. The controller 820 may refer to a circuitry, an application-specific integrated circuit (ASIC), or at least one processor. The transceiver 810, the controller 820 and the memory 830 are configured to perform the operations of the UE illustrated in the figures, e.g., FIGS. 1 to 7 or described above. Although the transceiver 810, the controller 820 and the memory 830 are shown as separate entities, they may be realized as a single entity like a single chip. Alternatively, the transceiver 810, the controller 820 and the memory 830 may be electrically connected to or coupled with each other.

The transceiver 810 may transmit and receive signals to and from other network entities, e.g., a base station.

The controller 820 may control the UE to perform functions according to one of the embodiments described above.

For example, the controller 820 is configured to transmit, to a first base station operating a first cell, a first message related to a random access procedure, the first message including information indicating whether the terminal needs broadcast information of a second cell, receive, from the first base station, a second message as an acknowledgement of the first message, and receive, from a second base station operating the second cell, the broadcast information.

In an embodiment, the operations of the terminal may be implemented using the memory 830 storing corresponding program codes. Specifically, the terminal may be equipped with the memory 830 to store program codes implementing desired operations. To perform the desired operations, the controller 820 may read and execute the program codes stored in the memory 830 by using a processor or a central processing unit (CPU).

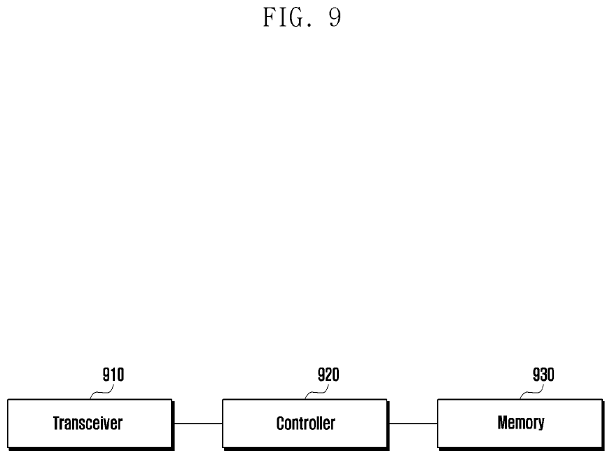

FIG. 9 illustrates a block diagram of a base station according to an embodiment of the present disclosure.

Referring to FIG. 9, a base station includes a transceiver 910, a controller 920 and a memory 930. The base station may operate Cell 1 of the above embodiments. Alternatively, the base station may operate Cell 2 of the above embodiments. The transceiver 910, the controller 920 and the memory 930 are configured to perform the operations of the network (e.g., gNB) illustrated in the figures, e.g., FIGS. 1 to 7 or described above. Although the transceiver 910, the controller 920 and the memory 930 are shown as separate entities, they may be realized as a single entity like a single chip. The transceiver 910, the controller 920 and the memory 930 may be electrically connected to or coupled with each other.

The transceiver 910 may transmit and receive signals to and from other network entities, e.g., a terminal.

The controller 920 may control the base station to perform functions according to one of the embodiments described above. The controller 920 may refer to a circuitry, an ASIC, or at least one processor.

For example, the controller 920 is configured to receive, from a terminal, a first message related to a random access procedure, the first message including information indicating whether the terminal needs broadcast information of a second cell, transmit, to a second base station operating the second cell, information indicating the broadcast information based on the first message, and transmit, to the terminal, a second message as an acknowledgement of the first message.

In an embodiment, the operations of the base station may be implemented using the memory 930 storing corresponding program codes. Specifically, the base station may be equipped with the memory 930 to store program codes implementing desired operations. To perform the desired operations, the controller 920 may read and execute the program codes stored in the memory 930 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
transmitting, to a first base station operating a first cell, a first message related to a random access procedure, the first message including information indicating whether the terminal needs broadcast information of a second cell;
receiving, from the first base station, a second message as an acknowledgement of the first message; and
receiving, from a second base station operating the second cell, the broadcast information.

2. The method of claim 1, wherein the first message further includes at least one of a physical cell identifier (PCI) of the second cell or carrier frequency information of the second cell.

3. The method of claim 1, wherein:
the random access procedure is a 4-step random access procedure;
the first message is a message 3 (Msg3); and
the second message is a message 4 (Msg4).

4. The method of claim 1, wherein:
the random access procedure is a 2-step random access procedure;
the first message is a message A (MsgA); and
the second message is a message B (MsgB).

5. The method of claim 1, wherein the broadcast information includes at least one of a primary synchronization signal (PSS), a secondary synchronization signal (SSS), a master information block (MIB), a system information block 1 (SIB1), or other system information (OSI).

6. A method performed by a first base station operating a first cell in a wireless communication system, the method comprising:
receiving, from a terminal, a first message related to a random access procedure, the first message including information indicating whether the terminal needs broadcast information of a second cell;
transmitting, to a second base station operating the second cell, information indicating the broadcast information, based on the first message; and
transmitting, to the terminal, a second message as an acknowledgement of the first message.

7. The method of claim 6, wherein the first message further includes at least one of a physical cell identifier (PCI) of the second cell or carrier frequency information of the second cell.

8. The method of claim 6, wherein:
the random access procedure is a 4-step random access procedure;
the first message is a message 3 (Msg3); and
the second message is a message 4 (Msg4).

9. The method of claim 6, wherein:
the random access procedure is a 2-step random access procedure;
the first message is a message A (MsgA); and
the second message is a message B (MsgB).

10. The method of claim 6, wherein the broadcast information includes at least one of a primary synchronization signal (PSS), a secondary synchronization signal (SSS), a master information block (MIB), a system information block 1 (SIB1), or other system information (OSI).

11. A terminal in a wireless communication system, the terminal comprising:
a transceiver; and
a controller coupled with the transceiver and configured to:
transmit, to a first base station operating a first cell, a first message related to a random access procedure, the first message including information indicating whether the terminal needs broadcast information of a second cell,
receive, from the first base station, a second message as an acknowledgement of the first message, and
receive, from a second base station operating the second cell, the broadcast information.

12. The terminal of claim 11, wherein the first message further includes at least one of a physical cell identifier (PCI) of the second cell or carrier frequency information of the second cell.

13. The terminal of claim 11, wherein:
the random access procedure is a 4-step random access procedure;
the first message is a message 3 (Msg3); and
the second message is a message 4 (Msg4).

14. The terminal of claim 11, wherein:
the random access procedure is a 2-step random access procedure;
the first message is a message A (MsgA); and
the second message is a message B (MsgB).

15. The terminal of claim 11, wherein the broadcast information includes at least one of a primary synchronization signal (PSS), a secondary synchronization signal (SSS), a master information block (MIB), a system information block 1 (SIB1), or other system information (OSI).

16. A first base station operating a first cell in a wireless communication system, the first base station comprising:
a transceiver; and
a controller coupled with the transceiver and configured to:
receive, from a terminal, a first message related to a random access procedure, the first message including information indicating whether the terminal needs broadcast information of a second cell,
transmit, to a second base station operating the second cell, information indicating the broadcast information, based on the first message, and
transmit, to the terminal, a second message as an acknowledgement of the first message.

17. The first base station of claim 16, wherein the first message further includes at least one of a physical cell identifier (PCI) of the second cell or carrier frequency information of the second cell.

18. The first base station of claim 16, wherein:
the random access procedure is a 4-step random access procedure;
the first message is a message 3 (Msg3); and
the second message is a message 4 (Msg4).

19. The first base station of claim 16, wherein:
the random access procedure is a 2-step random access procedure;
the first message is a message A (MsgA); and
the second message is a message B (MsgB).

20. The first base station of claim 16, wherein the broadcast information includes at least one of a primary synchronization signal (PSS), a secondary synchronization signal (SSS), a master information block (MIB), a system information block 1 (SIB1), or other system information (OSI).
